(19) United States
(12) Patent Application Publication
(10) Pub. No.: US 2023/0122222 A1
(43) Pub. Date: Apr. 20, 2023

(54) DEVICE, SYSTEM, AND METHOD FOR BIOMETRICALLY IDENTIFYING A USER OF A DEVICE

(71) Applicants: Robert Bosch GmbH, Stuttgart (DE); TRUMPF Photonic Components GmbH, Ulm (DE)

(72) Inventors: Johannes Meyer, Haseluenne (DE); Thomas Alexender Schlebusch, Renningen (DE); Andreas Petersen, Eningen (DE); Jochen Hellmig, VALKENSWAARD (NL); Hans Spruit, WAALRE (NL)

(21) Appl. No.: 17/967,932

(22) Filed: Oct. 18, 2022

(30) Foreign Application Priority Data
Oct. 18, 2021 (DE) 10 2021 126 907.5

(51) Int. Cl. G06V 40/18; G06V 10/60; G06V 10/774

(52) U.S. Cl. CPC G06V 40/197; G06V 10/60; G06V 10/774

(57) ABSTRACT

A method (600), a device (100), and a system (700) for biometrically identifying a user of a device (100).

### BACKGROUND OF THE INVENTION

The disclosure relates to a device, a system, and a method for biometrically identifying a user of a device.

Biometric authentication systems in which the authentication is based upon the biometric properties of the eye are known from the prior art. High-resolution cameras are used in systems of this kind to analyze the unique features of the eye, and in particular the iris. These systems are referred to as iris scanners. Other methods utilize the eye movements and the eye movement characteristics, wherein the biometric features are detected for the authentication process using video oculography, or VOG, systems. For this purpose, for example, a front camera of a smartphone or a video oculography, or VOG, eye tracker can be used. A system of this kind is known, for example, from US 2017/083695 A.

A disadvantage of known systems is that the VOG systems require a large amount of energy to permanently track eye movement. A low temporal resolution of the recorded signals can have a negative effect on precise feature extraction - particularly in the case of saccadic movements.

### SUMMARY OF THE INVENTION

These disadvantages are overcome with a device, a system, and a method for biometrically identifying the user of a device according to the independent claims.

One embodiment relates to a method for biometrically identifying the user of a device having at least one laser/photodiode unit, comprising a laser light source — in particular, a laser diode — and at least one photodetector — in particular, a photodiode — assigned to the laser light source. The method comprises the following steps:
emitting laser radiation onto an eye of the user;
detecting and evaluating a backscattered and/or reflected fraction of the laser radiation;
determining at least one variable related to the eye of the user - in particular, related to a movement of the eye of the user, based upon the evaluation of the backscattered and/or reflected fraction of the laser radiation;
deriving at least one biometric feature from the variables related to the eye of the user, and
determining an identity of the user based upon the at least one biometric feature.

The operating principle of a laser is based upon optical resonators. Within the resonator, the electrons are excited by means of an external energy supply. The radiation generated by spontaneous emission is reflected back and forth in the optical resonator and results in stimulated emission, thereby amplifying the resonance mode and generating coherent radiation.

In a particularly preferred embodiment of the method according to the invention, a surface emitter is used as the laser diode. A surface emitter, also referred to as a VCSEL (vertical-cavity surface-emitting laser), has various advantages over an edge emitter. Above all, a VCSEL requires only very little space — in particular, a sensor installation space of < 200 × 200 µm — so that a laser beam generating unit of this kind is particularly suitable for miniaturized applications. Furthermore, a VCSEL is relatively cheap in comparison with conventional edge emitters and requires only little energy. With regard to the measuring principle, which is based upon the method according to the invention, and also with regard to the use of VCSEL’s for miniaturized applications, reference is made to the publication by Pruijmboom et al., “VCSEL-based miniature laser-Doppler interferometer” (Proc. of SPIE, Vol. 6908, 690801-1-7).

In the case of a vertical-cavity surface-emitting laser (VCSEL), the mirror structures are designed as distributed Bragg reflectors (DBR). On one side of the laser cavity, the DBR reflector has a transmittance of approximately 1%, so that the laser radiation can couple out into the free space.

In a particularly preferred embodiment of the method according to the invention, a surface emitter unit is used which has an integrated photodiode or, optionally, several photodiodes, which is also referred to as ViP (VCSEL, vertical-cavity surface-emitting laser, integrated photodiode). The backscattered or reflected laser light, which interferes with the standing wave in the laser cavity, can be analyzed directly by means of the integrated photodiode. When producing a corresponding surface emitter unit, the photodiode may be integrated directly during production of the laser diode, which is produced, for example, as a semiconductor component, in the course of semiconductor processing.

In the case of a ViP, the photodiode is located on the other side of the laser resonator, such that the photodiode does not interfere with the coupling into the free space. A particular feature of the ViP is the direct integration of the photodiode into the lower Bragg reflector of the laser. As a result, the size is decisively determined by the lens used, which allows for sizes of the laser/photodiode unit of < 2 × 2 mm. As a result, the ViP can be integrated so as to be almost invisible to a user - for example, in data glasses.

In a particularly advantageous manner, the backscattered and/or reflected radiation is evaluated on the basis of optical feedback interferometry. The measuring principle underlying the method is preferably based upon the method also referred to as self-mixing interference (SMI). In this case, a laser beam is reflected onto an object and scattered or reflected back into the laser cavity generating the laser. The reflected light then interferes with the beam that is generated in the laser cavity, i.e., primarily with a corresponding standing wave in the laser cavity, resulting in changes in the optical and/or electrical properties of the laser. Typically, this results in fluctuations in the intensity of the output power of the laser. Information concerning the object on which the laser beam was reflected or scattered can be obtained from an analysis of these changes.

If double the distance between the laser/photodiode unit and the object on which the radiation is scattered and reflected is an integer multiple of the wavelength of the laser radiation, the scattered radiation and the radiation in the laser/photodiode unit are in phase. This leads to positive/constructive interference, as a result of which the laser threshold is lowered, and the laser power slightly increased. At a slightly larger distance than an integer multiple, both radiation waves are out of phase, and negative interference occurs. The laser output power is reduced. If the distance between the laser/photodiode unit and the object on which the radiation is scattered and reflected is changed at a constant speed, the laser power fluctuates between a maximum in the case of constructive interference and a minimum in the case of destructive interference. The resulting oscillation is a function of the speed of the object and the laser wavelength.

The variables related to the eye of the user — in particular, related to a movement of the eye of the user — which are determined based upon the evaluation of the backscattered and/or reflected fraction of the laser radiation, include, for example, at least one or more of the following variables:
a distance — in particular, a distance and/or distance profile between the device and eye; a speed — in particular of a movement of the eye, and in particular a velocity component parallelto the laser beam; an acceleration – in particular, of a movement of the eye, an eye rotation angle, and/or a change in the eye rotation angle; and/or a signal-to-noise ratio, SNR, as a parameter of the signal strength.

The biometric features derived from the variables related to the eye of the user include, for example, at least one or more of the following biometric features: a distance or distance profile between the device — in particular, the laser/photodiode unit —and a surface of the eye — in particular, the step in the eye surface between the sclera and the iris and/or the distance between the iris and the retina; a speed — in particular, a maximum speed and/or a speed profile; an acceleration — in particular a peak acceleration and/or an acceleration profile; an eye position; a reaction time; a fixation duration; blinking; a gaze path; a gaze gesture; saccadic movements and/or saccadic directions — in particular, in connection with specific activities, such as reading, playing, viewing video content and/or when idle, i.e., without a specific task.

Furthermore, a reflectivity of different regions on the eye surface, e.g., the iris or sclera, and/or speckle effects can also be used as biometric features. When the laser beam passes through a defined path and/or during a movement of the eye, speckle effects can interfere with the distance measurement. These interferences depend upon the unique surface properties of the eye surface, which, for example, include grooves or rings through which the laser beam passes.

In comparison with the VOG system known from the prior art, a significantly higher temporal resolution is possible in the detection and evaluation of the backscattered and/or reflected radiation with a laser/photodiode unit – in particular, in the form of a ViP (VCSEL, vertical-cavity surface-emitting laser, integrated photodiode). This enables precise detection and evaluation with high accuracy – in particular, in the case of speed, reaction, or acceleration-based variables.

Furthermore, the described method makes it possible to derive some biometric features that cannot be derived with a VOG system. Such biometric features are, for example, a distance or distance profile between the device — in particular, the laser/photodiode unit — and a surface of the eye, the reflectivity of different regions on the eye surface, and speckle effects in the distance measurement.

An identity of the user is determined on the basis of the biometric features. Determining the identity based upon the biometric features may involve classifying the biometric features. A classifier or a combination of classifiers is used for the classification. Possible classifiers are statistical classifiers such as Gaussian mixture models, time-series classifiers such as recurrent neural networks, neural networks, or histogram-based classifiers. Determining an identity of the user based upon the biometric features may advantageously comprise comparing the biometric features with — in particular, previously acquired — reference data related to biometric features of a user or a plurality of users.

According to an advantageous development of the invention, the laser radiation may be emitted at a constant frequency or wavelength, or the laser radiation may be emitted at a modulated frequency or wavelength. The frequency or wavelength of the laser radiation can be modulated, for example, by modulating a laser current. Periodic modulation of the laser current, as a result of which the wavelength of the laser beam is periodically changed, may be advantageous. In a particularly advantageous manner, by analyzing the backscattered or reflected radiation that interferes with the generated laser current, the optical path length between the laser generating unit or the laser diode and the object, i.e., the retina of the eye, can be determined from the resulting intensity fluctuations of the laser output power. When the wavelength is changed, the same effect thus occurs with respect to the change in the distance between the laser/photodiode unit and the object on which the radiation is scattered and reflected.

Modulations of the wavelength can be induced by modulating the power of the laser/photodiode unit. For example, linear modulation with a triangular laser current is conceivable. Other known modulation methods such as quadrature, sine, and piecewise combinations of the former may also be used. The frequency of the laser radiation generated follows the change in current almost instantaneously. The resulting frequency difference between the generated radiation and the reflected radiation can be detected and evaluated. The wavelength of the laser radiation is, for example, in the range of about 700 nm to 1,400 nm - for example, in the near-infrared range around 850 nm. The distance between the laser/photodiode unit and the object on which the laser radiation is reflected is a multiple of the wavelength, and in particular at least several centimeters. Therefore, a slight change in the laser wavelength can lead to a complete rotation of the phase of the reflected laser radiation. The greater the distance is, the smaller the wavelength change, which leads to a complete change in the phase of the reflected laser radiation. If the variation of the laser power is taken into account, the frequency of the power variation with a constant change in the laser wavelength turns out to be higher, the greater the distance between the laser/photodiode unit and the reflecting object. By mapping the signal of the power-monitoring photodiode in the frequency domain, the peak frequency correlates with the distance from the reflecting object; cf. in this regard Grabherr et al: Integrated photodiodes complement the VCSEL platform. In: Proc. of SPIE, vol. 7229, doi: 10.1117/12.808847.

If both effects overlap, viz., the change in the distance between the laser/photodiode unit and the reflecting object and the frequency modulation, beat frequencies of the kind known from frequency-modulated, continuous-wave radars, FMCW, are generated. Due to the Doppler shift of the frequency, the resulting beat frequency for an object moving towards the sensor is lower when the frequency increases and higher when the frequency decreases. Therefore, the beat frequencies for rising and falling modulation segments are to be calculated individually. The mean value of the two frequencies is an indicator of the distance of the target, while the difference correlates with twice the Doppler frequency, and thus with the speed of the object.

It may prove advantageous if a switch takes place between laser radiation at a constant frequency and laser radiation at a modulated frequency.

According to another advantageous embodiment, the device comprises at least two laser/photodiode units, wherein it is possible to operate the at least two laser/photodiode units independently of one another. For example, operation with a time offset — in particular, time multiplexing — or multi-stage activation may be applied. In this way, the energy required by the device for carrying out the method can be reduced.

It can be provided that authentication be triggered when a movement is detected. The movement is, for example, a natural, non-stimulated eye movement. The detection triggers the authentication, for example - in particular, the execution of the steps of determining variables related to the eye of the user, deriving biometric features from the variables related to the eye of the user, and determining an identity of the user on the basis of the biometric features.

The method may comprise a step of triggering a movement of the eye of the user. An eye movement may be triggered, for example, by optical stimulation.

The device may be actuated as a function of an authentication, and in particular a successful and/or unsuccessful authentication. Actuation of the device involves, for example, normal and/or user-specific use in the case of successful authentication, and blocking in the event of unsuccessful authentication.

The method for biometrically identifying a user is carried out, for example, when the user starts using the device.

Determining an identity of the user based upon the biometric features may advantageously comprise comparing the biometric features with — in particular, previously acquired — reference data related to biometric features of a user or a plurality of users. In this context, it may prove advantageous if the method comprises at least one step of acquiring reference data related to biometric features of a user, and/or a step of training a classification for determining an identity of the user.

The reference data related to biometric features are acquired, for example, during setup — in particular, initial start-up — of the device. Additionally or alternatively, the reference data related to biometric features may be acquired when the user is using the device.

When the determination of an identity of the user based upon the biometric features takes place on the basis of a classification, it may prove advantageous if the method comprises a step of training the classification for determining an identity of the user. The reference data may be used as training data. Training takes place, for example, during setup — in particular, initial start-up — of the device. Additionally or alternatively, the training may also take place when the user is using the device.

Further embodiments relate to a device — in particular data glasses — having at least one laser/photodiode unit and at least one computing means for carrying out steps of the method according to the described embodiments.

The computing means of the device may in particular be designed to carry out one or more of the following steps of the method: evaluating a backscattered and/or reflected fraction of the laser beam; determining variables related to the eye of the user - in particular, related to a movement of the eye of the user, based upon the evaluation of the backscattered and/or reflected fraction of the laser beam; deriving biometric features from the variables related to the eye of the user; and/or determining an identity of the user on the basis of the biometric features.

The use of a laser/photodiode unit — in particular, a ViP (VCSEL, vertical-cavity surface-emitting laser, integrated photodiode) — allows for cost-effective and simple integration into the device - particularly in comparison with VOG systems.

According to one embodiment, the device is designed to superimpose image information into the field of view of the user. The image information may be projected onto a retina of the user, for example. This is done, for example, by means of reflection via a partially transparent mirror or by means of a diffraction grating in a special spectacle lens or via a prism lens. In the case of data glasses — in particular, AR/VR smartglasses, AR augmented reality, VR virtual reality, mixed reality, smartglasses — such optical elements are integrated into the spectacle lens, for example. According to further embodiments, the device is, for example, a device for front and side window projection in a vehicle, e.g., in a vehicle interior, or a display, e.g., a retina scanner display, also referred to as a virtual retinal display or light field display.

By means of the superimposed image information, an eye movement in particular can be triggered according to the disclosed method – in particular, for triggering the authentication method.

Further embodiments relate to a system comprising a device according to the described embodiments and a computing means. The device and the computing means are designed to carry out steps of the described method. Steps of the method may, advantageously, be provided at least in part by the device, and in particular the computing means of the device, and at least in part by the computing means of the system. The computing means of the system is provided, for example, by a terminal — in particular, assigned to a user of the device, and in particular a remote terminal in the wireless body network of the user — for example, a smartphone or a smartwatch or a tablet. Alternatively or additionally, the computing means of the system may be provided, for example, by a remote, and in particular cloud-based, server.

### BRIEF DESCRIPTION OF THE DRAWINGS

Further embodiments can be found in the following description and in the drawings, in which:

FIG. 1 is a schematic representation of a detail of a device for biometrically identifying a user according to one embodiment;

FIG. 2 is a schematic representation of a detail of a device for biometrically identifying a user according to another embodiment;

FIG. 3 is a schematic representation of a detail of a device for biometrically identifying a user according to another embodiment;

FIG. 4 is a schematic representation of a frequency range spectrum according to a first embodiment;

FIG. 5 is a schematic representation of a frequency range spectrum according to another embodiment;

FIG. 6 is a schematic representation of steps of a method for biometrically identifying a user, and

FIG. 7 is a schematic representation of a system for biometrically identifying a user.

### DETAILED DESCRIPTION

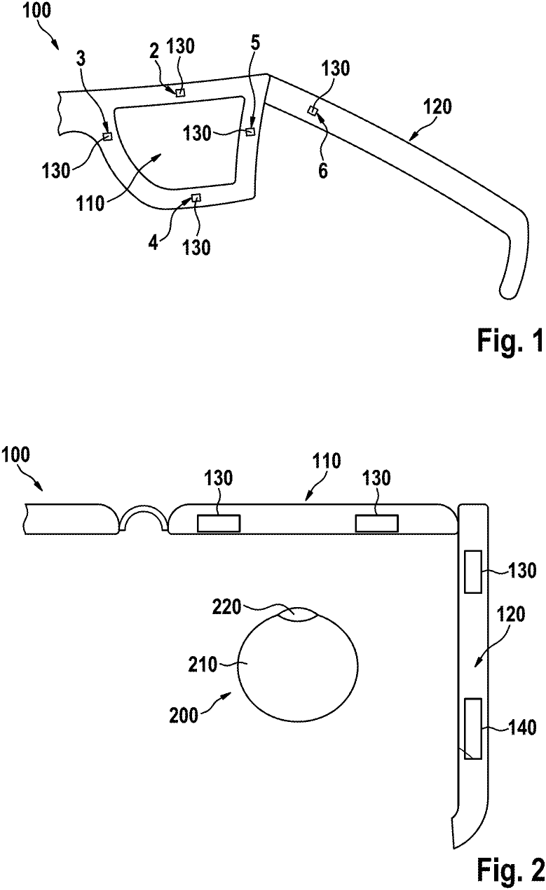

FIG. 1 shows a detail of a device 100. According to the embodiment shown, the device 100 is a pair of data glasses. Data glasses usually comprise two spectacle lenses and two temples, wherein one spectacle lens 110 and one temple 120 are shown in FIG. 1.

According to this representation, the device 100 comprises several laser/photodiode units 130. It is also conceivable for the device 100 to comprise only one laser/photodiode unit 130. A quantity of at least two laser/photodiode units 130 may be advantageous.

A laser/photodiode unit 130 is, advantageously, a surface emitter unit which has an integrated photodiode or, optionally, several photodiodes and which is also referred to as a ViP (VCSEL, vertical-cavity surface-emitting laser, integrated photodiode). The laser/photodiode unit 130 comprises actuation electronics (not shown).

In principle, for the purposes of the invention, laser radiation of a wavelength which can pass through the lens in the eye and which is then reflected by the retina of the eye can be used. In a particularly preferred manner, the wavelength of the laser beam used is selected so as to be in the near-infrared range. Near-infrared is close to the visible red range. For example, wavelengths from the range of about 700 nm to 1,400 nm, and in particular 780 nm to 1,040 nm, may be used. Infrared radiation generally has the advantage that it is not visible to the human eye and therefore does not interfere with sensory perception at the eye. It is not damaging to the eye, and, furthermore, there are already suitable laser sources which can advantageously be used for the purposes of the invention. In principle, it is also possible to use several wavelengths which are preferably, spectrally, not close to one another.

According to FIG. 1, four laser/photodiode units 130 are arranged on a frame of the device around the spectacle lens 110. Another laser/photodiode unit 130 is arranged on the temple 120.

The laser/photodiode units 130 may also be integrated into the spectacle lens or into additional components of the data glasses - for example, nose pads.

FIG. 2 is a further representation of the device 100. Furthermore, an eye 200 with an eyeball 210 and a lens 220, which is located below the cornea (not shown here in more detail) and the pupil with the surrounding iris, is schematically indicated.

The laser radiation generated by a laser/photodiode unit 130 is emitted in the direction of the eye.

On the basis of optical feedback interferometry, laser radiation that enters the laser/photodiode unit 130 again due to reflection and scattering leads to intensity fluctuations in the output power of the laser. These intensity fluctuations are detected and evaluated, for example, by means of the photodiode integrated into the laser/photodiode unit 130.

The evaluation is carried out, for example, by means of a schematically indicated computing means 140 of the device 100.

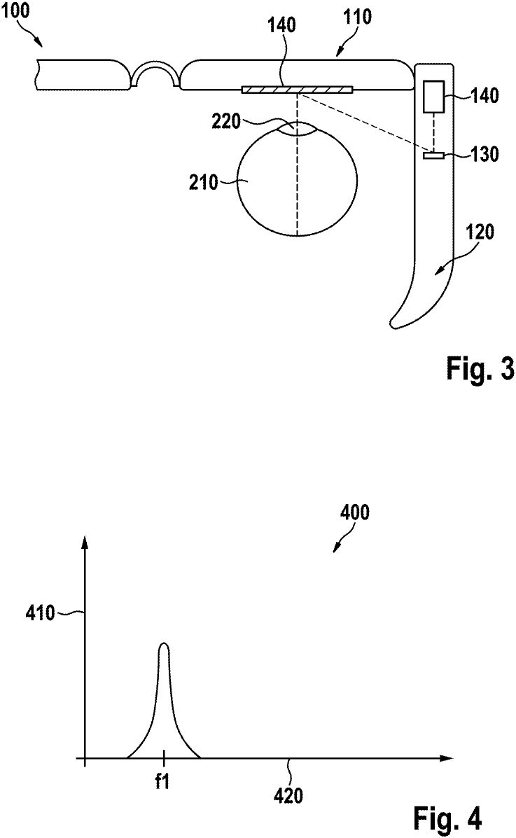

FIG. 3 is another representation of the device 100. According to the representation in FIG. 3, a laser/photodiode unit 130 is arranged in the temple, but emits radiation towards the spectacle lens.

The laser/photodiode unit 130 may also be used to superimpose image information into the field of view of the user. The image information may be projected directly onto the retina. In the case of data glasses for so-called augmented reality, AR, virtual image content is superimposed onto the real environment in that the virtual content is introduced as visual information into the normal field of vision of the human eye. This is done, for example, by means of reflection via a partially transparent mirror or by means of a diffraction grating in a special spectacle lens or via a prism lens. As a rule, these virtual images are superimposed in front of the eye at a fixed focal distance.

According to FIG. 3, a holographic optical element (HOE) 150 embedded in the spectacle lens deflects the laser radiation towards the eye.

The laser/photodiode unit 130 may be operated at a constant frequency or at a modulated frequency.

FIG. 4 shows an exemplary representation of a frequency range spectrum 400 for the case where a laser/photodiode unit 130 is operated at a constant frequency and where the object, e.g., the eye 200, on which the laser radiation is reflected moves at a constant speed. In FIG. 4, the amplitude 410 is plotted against the frequency 420. In this case, the peak frequency f1 corresponds to the Doppler frequency. In this case, the absolute value of the velocity vector of the moving object can be determined.

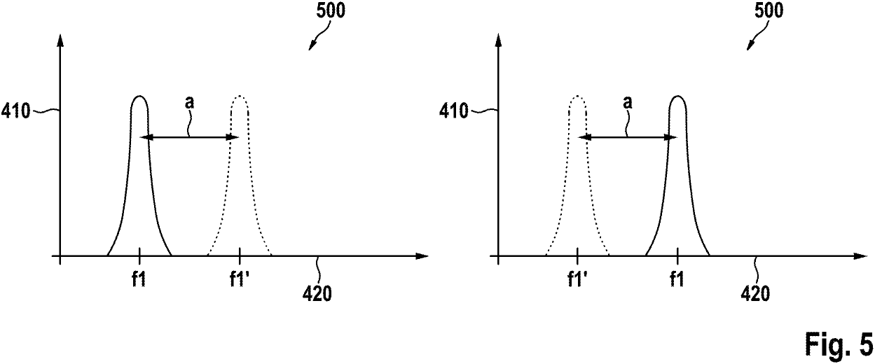

FIG. 5 is an exemplary representation of a frequency range spectrum 500 for the case where a laser/photodiode unit 130 is operated at a modulated frequency. If the object were not to move, a spectrum 400 as in FIG. 4 would result. If the object, e.g., the eye 200, on which the laser radiation is reflected moves again at a constant speed, a spectrum as in FIG. 5 results. In this case, the distance a between the laser/photodiode unit 130 and the object can be determined via the peak frequency f1, f1′. With additional movement of the object, the peak frequency f1, f1′ shifts upwards or downwards; cf. to the left or to the right in FIG. 5. The direction of displacement is dependent upon the modulation ramp with which the laser is operated up or down, and the direction of the velocity vector with which the object moves with respect to the laser/photodiode unit 130 - towards the laser/photodiode unit 130 or away from the laser/photodiode unit 130. FIG. 5 shows the two spectra for falling and rising modulation ramps (left and right). The distance between the peak frequencies can be used to determine the direction and absolute value of the movement of the object.

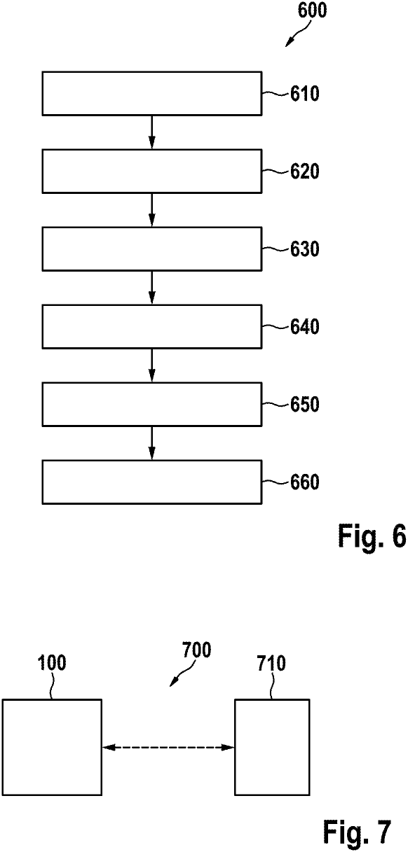

FIG. 6 schematically illustrates steps of a method 600 for biometrically identifying a user. The steps of the method are carried out, for example, at least in part by a device 100 according to one of the embodiments shown in FIGS. 1 through 3.

The method 600 comprises, for example, the following steps:
a step 610 of emitting laser radiation onto the eye 200 of the user;
a step 620 of detecting and a step 630 of evaluating a backscattered and/or reflected fraction of the laser beam;
a step 640 of determining variables related to the eye 200 of the user — in particular, related to a movement of the eye 200 of the user — based upon the evaluation of the backscattered and/or reflected fraction of the laser beam;
a step 650 of deriving biometric features from the variables related to the eye of the user; and
a step 660 of determining an identity of the user on the basis of the biometric features.

The backscattered and/or reflected fraction of the laser radiation can be evaluated 630 on the basis of the above-described optical feedback interferometry.

The variables related to the eye of the user – in particular, related to a movement of the eye of the user, which are determined 640 on the basis of the evaluation of the backscattered and/or reflected fraction of the laser radiation, include, for example, at least one or more of the following variables:
a distance - in particular, a distance and/or distance profile between the device and eye; a speed - in particular, of a movement of the eye, and in particular a velocity component parallel to the laser beam; an acceleration - in particular, of a movement of the eye, and in particular by deriving speed-time series data; an eye rotation angle and/or a change in the eye rotation angle - in particular, by integrating speed-time series data; and/or a signal-to-noise ratio, SNR, as a parameter of the signal strength. Typical speeds of movements of the eye are in the range of 0 to 800°/s. Various speeds can be assigned to various types of movements of the eye. These are, for example:
microsaccades, also called drift or tremor, at speeds of 0.033°/s to 2°/s and with a typical duration of 150 ms to 600 ms and an occurrence frequency of > 1 Hz;
tracking movements, also called smooth pursuits, with speeds of 2 to 75°/s; and saccades at speeds of up to 800°/s and with durations of between 10 ms and 150 ms and with an occurrence frequency of 10 Hz to 100 Hz.

In addition to the above-mentioned variables, it is particularly advantageous — in particular, additionally — to determine the upward and/or downward movement of the eyelid during blinking and/or the time in which the eye is closed. Blinking can be described with typical speeds of up to 180 mm/s with a duration of 20 ms to 200 ms and frequencies of 10 Hz to 15 Hz.

The biometric features derived 650 from the variables related to the eye of the user include, for example, at least one or more of the following biometric features: a distance or distance profile between the device and a surface of the eye – in particular, the step in the eye surface between the sclera and the iris and/or the distance between the iris and the retina; a speed — in particular, a maximum speed and/or a speed profile; an acceleration — in particular, a peak acceleration and/or an acceleration profile, e.g., as a function of the movement amplitude; an eye position; a reaction time; a fixation duration; a fixation frequency; a distribution of the fixation in the viewing angle or display coordinate system; blinking; a gaze path; a gaze gesture; saccadic movements and/or saccadic directions – in particular in connection with specific activities, e.g., reading, playing, viewing video content, and/or when idle, i.e., without a specific task; a duration and/or frequency and/or speeds of the saccades; an amplitude of the saccades – in particular, in the horizontal and vertical directions; a statistical and/or algebraic description of speed and/or amplitude curves, e.g., a maximum gradient during acceleration and braking, a maximum amplitude, an average speed, a ratio of acceleration or speed to amplitude, derived variables from fitting “learned” distributions, e.g., polynomial fitting of peak amplitude speed to amplitude – all of the above-mentioned variables individually or in all possible combinations. In connection with the blinking, the following variables can be derived, in particular: a duration and/or frequency of blinking; a duration for which the eyelid is closed; a distance distribution during the process of the eyelid closing; amplitudes and speed distributions when the eyelid closes; a statistical relationship between the speed and duration of the eyelid closing; a time interval between multiple instances of the eyelid closing; derived variables from fitting “learned” distributions, e.g., polynomial fitting of peak blinking speed to duration of the eye being closed.

The determination 660 of the identity on the basis of the biometric features may comprise a classification of the biometric features. A classifier or a combination of classifiers is used for the classification. Possible classifiers are statistical classifiers such as Gaussian mixture models, support vector machines, random forest classifiers, or time-series classifiers such as recurrent neural networks, neural networks, or histogram-based classifiers. An algorithm that uses a neural network is known, for example, from EP 3 295 371 A1.

According to an advantageous development of the method, laser radiation can be emitted 610 at a constant frequency or at a modulated frequency.

It may also be advantageous for a switch to take place between laser radiation with a constant frequency and laser radiation with a modulated frequency.

If the device 100 comprises at least two laser/photodiode units 130, the at least two laser/photodiode units 130 can be operated independently of one another.

It can be provided that authentication be triggered when a movement is detected. The movement is, for example, a natural, non-stimulated eye movement. The detection triggers authentication, for example - in particular, the performance of steps 640 through 660, i.e., determining variables related to the eye of the user, deriving biometric features from the variables related to the eye of the user, and determining an identity of the user on the basis of the biometric features.

The method 600 may comprise a step of triggering a movement of the eye of the user. An eye movement may be triggered, for example, by optical stimulation. The optical stimulation may take place, for example, in that the laser/photodiode unit 130 is used to superimpose image information into the field of view of the user. This optical stimulation may involve specific patterns such as circles, spirals, or dots, or an unlocking pattern or a gaze movement path which the user tracks with their gaze. Furthermore, movable and static Ul objects such as buttons, sliders, text boxes, etc., may be used to trigger movements.

Actuation of the device 100 may take place as a function of an authentication, and in particular a successful and/or unsuccessful authentication. The actuation of the device 100 involves, for example, normal and/or user-specific use in the case of successful authentication, and blocking in the event of unsuccessful authentication.

The method 600 for biometrically identifying a user is carried out, for example, when the user starts using the device 100.

The determination 660 of an identity of the user on the basis of the biometric features may, advantageously, comprise a comparison of the biometric features with — in particular, previously acquired — reference data related to biometric features of a user or a plurality of users. In this context, it may prove advantageous if the method 600 comprises at least one step of acquiring reference data related to biometric features of a user, and/or a step of training a classification for determining an identity of the user.

The reference data related to biometric features are acquired, for example, during setup, and in particular initial start-up, of the device 100. Additionally or alternatively, the reference data related to biometric features may also be acquired when the user is using the device 100.

When the determination of an identity of the user based upon the biometric features takes place on the basis of a classification, it may prove advantageous if the method comprises a step of training the classification for determining an identity of the user. The reference data may be used as training data. The training takes place, for example, during setup, and in particular initial start-up, of the device 100. Additionally or alternatively, the training may also take place when the user is using the device 100.

FIG. 7 illustrates a system 700 for biometrically identifying a user. The system 700 comprises a device 100 — in particular, according to the embodiments described with reference to FIGS. 1 through 3 — and a computing means 710. The device 100 and the computing means 710 are designed to carry out steps of the described method 600. Steps of the method 600 may, advantageously, be provided at least in part by the device 100 — in particular, the computing means of the device — and at least in part by the computing means 710 of the system 700. The computing means 710 of the system is provided, for example, by a terminal — n particular, assigned to a user of the device 100, and in particular a remote terminal in the wireless body network of the user — for example, a smartphone or a smartwatch or a tablet. Alternatively or additionally, the computing means 710 of the system 700 may be provided, for example, by a remote, and in particular cloud-based, server. Data can be exchanged between the device 100 and the computing means 710. For this purpose, it has proven advantageous if the device 100 comprises a communications means for exchanging data with the computing means 710.

For example, it can be provided that the device 100 — in particular, the computing means of the device 100 — and/or the computing means 710 of the system 700 execute one or more of the following steps of the method 600:
evaluating 630 a backscattered and/or reflected fraction of the laser beam; determining 640 variables related to the eye 200 of the user – in particular, related to a movement of the eye 200 of the user, based upon the evaluation of the backscattered and/or reflected fraction of the laser beam;
deriving 650 biometric features from the variables related to the eye 200 of the user; and
determining 660 an identity of the user on the basis of the biometric features.

The described method 600, and/or the described device 100 and/or the described system 700, can be used, particularly advantageously, in the field of user interaction, human-machine interaction, HMI, and/or for a user-based optimization of projected content. Exemplary HMI applications are:
determining the identity of a user for unlocking the data glasses, e.g., automatic unlocking of the data glasses when the data glasses are put on, such that potentially complex and/or difficult input of a password is not required;
displaying personalized content, and in particular a personalized homepage; and
individually adapting gaze gestures for controlling the user interface.

Exemplary applications for optimizing projected content are:
individually adapting display settings, e.g., display brightness and/or contrast and/or colors – in particular, correcting colors;
individually adapting virtual content – for example with respect to projection depth, distance, position, white balance, reduction of the blue component; and/or
correcting the virtual content – in particular for users with vision problems.

According to one advantageous development, a combination with at least one or more additional sensors may prove advantageous. By way of example, the derivation 650 of biometric features and/or the determination 660 of the identity of the user may be improved based upon variables recorded by the at least one additional sensor. A light sensor may be used, for example, in order to reduce errors caused by pupil variations. For example, the use of a motion sensor – in particular, an acceleration or gyroscope sensor, and in particular for compensating for spectacle movement artifacts on the distance and speed measurement – has proven to be advantageous. Furthermore, the motion sensor may be used to detect the spectacles being put on and to activate the at least one laser/photodiode unit 130 – in particular, from a sleep mode, a low-power mode – in particular in order to start the method 600 and to carry out the steps of the method 600. Furthermore, by means of a combination of variables, distance and/or speed, for example, can, based upon the evaluation of the backscattered and/or reflected fraction of the laser radiation of the laser/photodiode unit 130, be determined; in combination with variables of the motion sensor, it can be determined when the data glasses are, in particular, correctly seated on the nose of the user, and thus when the variables determined on the basis of the evaluation of the backscattered and/or reflected fraction of the laser radiation are valid and can be used for the biometric detection.

1. A method (600) for biometrically identifying a user of a device (100) having at least one laser/photodiode unit (130), comprising a laser light source and at least one photodetector assigned to the laser light source, the method (600) comprising the following steps:
emitting (610) laser radiation onto an eye (200) of the user;
detecting (620) and evaluating (630) a backscattered and/or reflected fraction of the laser beam;
determining (640) at least one variable related to the eye (200) of the user based upon the evaluation of the backscattered and/or reflected fraction of the laser beam;
deriving (650) at least one biometric feature from the at least one variable related to the eye (200) of the user; and
determining (660) an identity of the user based upon the at least one biometric feature.

2. The method (600) according to claim 1, wherein the laser radiation is emitted (610) at a constant frequency or wherein the laser radiation is emitted (610) at a modulated frequency.

3. The method (600) according to claim 2, wherein a switch takes place between laser radiation with a constant frequency and laser radiation with a modulated frequency.

4. The method (600) according to claim 1, wherein the device (100) comprises at least two laser/photodiode units (130), and wherein the at least two laser/photodiode units (130) are operated independently of one another.

5. The method (600) according to claim 1, wherein authentication is triggered by detection of a movement.

6. The method (600) according to claim 1, wherein the method (600) comprises a step of triggering a movement of the eye (200) of the user.

7. The method (600) according to claim 1, wherein the determination (660) of an identity of the user based upon the at least one biometric feature takes place on the basis of a classification.

8. The method (600) according to claim 1, wherein actuation of the device (100) takes place as a function of an authentication.

9. The method (600) according to claim 1, wherein the method comprises at least one step of acquiring reference data related to at least one biometric feature of a user, and/or a step of training a classification for determining an identity of the user.

10. A device (100) comprising:
at least one laser/photodiode unit (130) having a laser light source and at least one photodetector; and
at least one computer (140) configured, in conjunction with the at least one laser/photodiode unit (130), to:
emit (610) laser radiation onto an eye (200) of the user;
detect (620) and evaluate (630) a backscattered and/or reflected fraction of the laser beam;
determine (640) at least one variable related to the eye (200) of the user based upon the evaluation of the backscattered and/or reflected fraction of the laser beam;
derive (650) at least one biometric feature from the at least one variable related to the eye (200) of the user; and
determine (660) an identity of the user based upon the at least one biometric feature.

11. The device (100) according to claim 10, wherein the device (100) is configured to superimpose image information into the field of view of the user.
